(19) United States
(12) Patent Application Publication
(10) Pub. No.: US 2019/0160483 A1
(43) Pub. Date: May 30, 2019

(54) COATING PATTERN FORMATION METHOD, COATING PATTERN FORMATION DEVICE, AND COATING-PATTERNED SUBSTRATE

(71) Applicant: TORAY ENGINEERING CO., LTD., Tokyo (JP)

(72) Inventors: Kenichi SHIMATANI, Otsu-shi, Shiga (JP); Satoshi TOMOEDA, Otsu-shi, Shiga (JP)

(21) Appl. No.: 16/313,190

(22) PCT Filed: Jun. 22, 2017
(86) PCT No.: PCT/JP2017/023041

§ 371 Date: Dec. 26, 2018

(30) Foreign Application Priority Data
Jun. 27, 2016 (JP) 2016-126862

(51) Int. Cl. B05C 5/00; B05D 1/26

(52) U.S. Cl. CPC B05C 5/002; B05D 1/26

(57) ABSTRACT

A coating pattern formation method includes adjusting lyophilicity of a pattern region provided on a substrate, and forming a coating pattern having a shape of the pattern region by applying a coating liquid to the pattern region after the adjusting of the lyophilicity of the pattern region. The lyophilicity of the pattern region is adjusted such that the pattern region is divided into a plurality of small pattern regions in at least one division direction, such that adjacent small pattern regions have different lyophilicity, such that a small pattern region spaced away from an end of the pattern region has the lowest lyophilicity among the small pattern regions in the at least one division direction, and such that the lyophilicity of the small pattern regions increases from the small pattern region having the lowest lyophilicity toward the end of the pattern region.

### CROSS-REFERENCE TO RELATED APPLICATIONS

This application is a U.S. National stage of International Application No. PCT/JP2017/023041 filed on Jun. 22, 2017. This application claims priority to Japanese Patent Application No. 2016-126862 filed with Japan Patent Office on Jun. 27, 2016. The entire disclosure of Japanese Patent Application No. 2016-126862 is hereby incorporated herein by reference.

### BACKGROUND

### Field of the Invention

The present invention relates to a coating pattern formation method, a coating pattern formation device, and a coating-patterned substrate with which a coating liquid is applied to a substrate by inkjet method to form a coating film in the desired shape.

### Background Information

In forming a coating pattern in the desired shape on a substrate, the use of an inkjet method has often been employed in recent years in place of using conventional photolithography. Whereas photolithography entails numerous steps such as coating, exposure, and etching, and consumes a large quantity of coating material in the etching step, an inkjet method allows a coating pattern to be formed in fewer steps and will almost no wasted coating material.

However, when a coating pattern is formed by inkjet method, the droplets spread out after landing on the substrate, and this makes it difficult to form the coating pattern according to the preset shape. Especially when the spacing between coating patterns is narrow, the coating patterns can end up being connected to each other, and there is the risk that the expected performance of the coating pattern will not be exhibited. In view of this, as shown in Japanese Patent Application Publication No. 2005-109390 (Patent Literature 1), a method is sometimes adopted in which the lyophilicity of the substrate is raised according to the shape of the coating pattern, and droplets are discharged in that portion. When this is done, the droplets spread out in the portion of higher lyophilicity, so a coating pattern having the preset shape can be easily formed.

### SUMMARY

However, even when a coating pattern is formed by the above method, there is a possibility that a coating pattern of the desired shape cannot be obtained with high accuracy. More specifically, as shown in FIG. 7A, when a pattern region 91 having higher lyophilicity than the surrounding area is formed in advance on the substrate W according to the shape of the coating pattern, and the pattern region 91 is coated with droplets to form the coating pattern 92 shown in FIG. 7B, surface tension acts on the coating pattern 92 as indicated by the arrows in FIG. 7B, so the coating pattern 92 is pulled in toward the center portion of the coating pattern 92, and as shown in FIG. 7C, there is a possibility that non-filled portions 93 can be formed at the corners of the coating pattern 92, for example.

The present invention is conceived in light of the above problem, and it is an object thereof to provide a coating pattern formation method, a coating pattern formation device, and a coating-patterned substrate with which a coating pattern can be formed according to a preset shape.

In order to solve the above problem, the coating pattern formation method of the present invention is a coating pattern formation method in which a coating liquid is applied to a pattern region provided on a substrate, to form a coating pattern having the shape of the pattern region, the method comprising a lyophilicity adjustment step of adjusting the lyophilicity of the pattern region, and a coating pattern formation step of forming a coating pattern by applying a coating liquid to the pattern region whose lyophilicity has been adjusted, wherein, in the lyophilicity adjustment step, the pattern region is divided into a plurality of small pattern regions in at least one direction, and the lyophilicity of the pattern region is adjusted such that adjacent small pattern regions will have different lyophilicity, and the small pattern regions other than those at the ends of the pattern region have the lowest lyophilicity in the division direction, which is the direction in which the pattern region is divided, and the lyophilicity of the small pattern regions increases from these small pattern regions having the lowest lyophilicity toward the ends of the pattern region.

With the above coating pattern formation method, the result of the lyophilicity adjustment step is that the small pattern regions other than the ends of the pattern region in the division direction have the lowest lyophilicity, and the lyophilicity is raised from these small pattern regions having the lowest lyophilicity toward the ends of the pattern region, which produces a flow from the inside of the coating pattern to the outside in the coating liquid that forms the coating pattern, and makes it possible for the coating liquid to be spread out all the way to the ends of the pattern region.

Also, it is preferable if, in the lyophilicity adjustment step, the small pattern regions are provided in at least the corners of the pattern region, and the lyophilicity of the pattern region is adjusted such that the lyophilicity of the small pattern regions in the corners will be the highest of the plurality of the small pattern regions forming the pattern region.

Doing this allows the coating liquid also to be spread out to the corners of the pattern region, where the coating liquid is less likely to spread.

Also, it is preferable if, in the lyophilicity adjustment step, the lyophilicity of the pattern region is adjusted such that the lyophilicity of the small pattern regions forming the ends of the pattern region will be higher than the lyophilicity of the portion that is outside the pattern region and is in contact with the pattern region.

Doing this prevents the coating liquid from spreading to outside the pattern region.

In order to solve the above problems, the coating pattern formation device of the present invention is a coating pattern formation device with which a coating liquid is applied to a pattern region provided on a substrate, to form a coating pattern having the shape of the pattern region, the device comprising a lyophilicity adjuster that adjusts the lyophilicity of the pattern region, and a coating component that forms a coating pattern by applying a coating liquid to the pattern region, wherein the lyophilicity adjuster divides the pattern region into a plurality of small pattern regions in at least one direction, and adjusts the lyophilicity of the pattern region such that adjacent small pattern regions will have different lyophilicity, and the small pattern regions other than those at the ends of the pattern region have the lowest lyophilicity in the division direction, which is the direction in which the pattern region is divided, and the lyophilicity of the small pattern regions increases from these small pattern regions having the lowest lyophilicity toward the ends of the pattern region.

With above-mentioned the coating pattern formation device, the lyophilicity adjuster causes the small pattern regions other than the ends of the pattern region in the division direction to have the lowest lyophilicity, and the lyophilicity of the small pattern regions rises from these small pattern regions having the lowest lyophilicity toward the ends of the pattern region, which produces a flow from the inside of the coating pattern to the outside in the coating liquid that forms the coating pattern, and makes it possible for the coating liquid to be spread out all the way to the ends of the pattern region.

Also, in order to solve the above problem, the coating-patterned substrate of the present invention is a coating-patterned substrate in which a coating pattern has been formed on at least part of the surface of a substrate, wherein a pattern region, which is a region of the substrate in contact with the coating pattern, is divided into a plurality of small pattern regions in at least one direction, and adjacent small pattern regions have different lyophilicity, and the small pattern regions other than those at the ends of the pattern region have the lowest lyophilicity in the division direction, which is the direction in which the pattern region is divided, and the lyophilicity of the small pattern regions increases from these small pattern regions having the lowest lyophilicity toward the ends of the pattern region.

With the above-mentioned coating-patterned substrate, in the division direction, the small pattern regions other than those at the ends of the pattern region have the lowest lyophilicity, and the lyophilicity of the small pattern regions rises from these small pattern regions having the lowest lyophilicity toward the ends of the pattern region, which produces a flow from the inside of the coating pattern to the outside in the coating liquid that forms the coating pattern, and makes it possible for the coating liquid to be spread out all the way to the ends of the pattern region.

The coating pattern formation method, coated pattern formation device, and coating-patterned substrate of the present invention make it possible to form a coating pattern according to a preset shape.

### BRIEF DESCRIPTION OF THE DRAWINGS

FIG. 1 is a simplified diagram of the coating pattern formation device in an embodiment of the present invention;

FIG. 2 is a diagram of the substrate before the formation of the coating pattern in this embodiment;

FIGS. 3A, 3B and 3C are diagrams of the division procedure for obtaining small pattern regions in this embodiment;

FIG. 4 is a cross section of the substrate immediately after the formation of the coating pattern in this embodiment;

FIG. 5 is a coating-patterned substrate formed on a substrate using the coating pattern formation method according to this embodiment;

FIGS. 6A and 6B are diagrams of the substrate according to another embodiment; and

FIGS. 7A, 7B and 7C are diagrams of the coating pattern formed by a conventional coating method.

### DETAILED DESCRIPTION OF EMBODIMENTS

Embodiments pertaining to the present invention will be described through reference to the drawings.

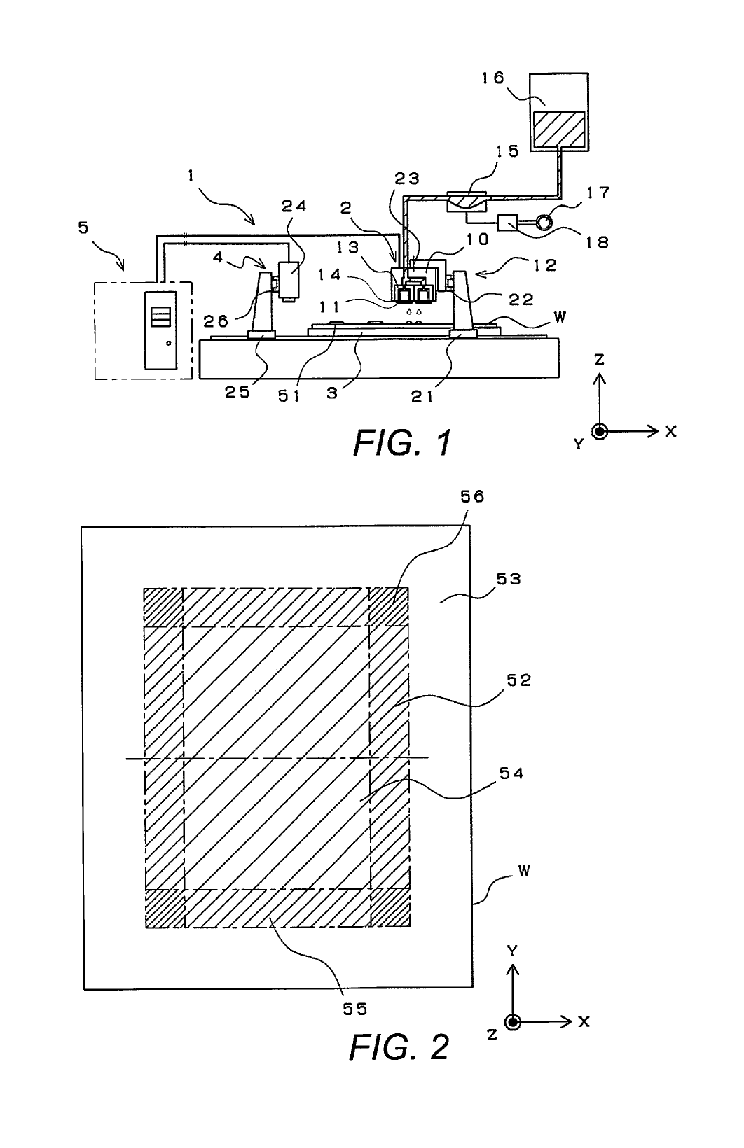

FIG. 1 is a simplified diagram of the coating pattern formation device in an embodiment of the present invention. A coating pattern formation device 1 comprises a coating component 2, a coating stage 3, a lyophilicity adjuster 4, and a controller 5. The coating of a substrate W is performed by moving the coating component 2 over the substrate W on the coating stage 3 while discharging droplets of coating liquid from nozzles inside the coating component 2. The droplets that land on the substrate W then link together, forming a coating pattern 51 on the substrate W. Before the coating component 2 discharges the droplets onto the substrate W, the lyophilicity adjuster 4 adjusts the lyophilicity of a pattern region 52, which is the region in which the coating pattern 51 is formed on the substrate W, and controls in advance the way in which the coating liquid spreads out after formation of the coating pattern.

In the following description, the direction in which the coating component 2 moves (scans) when droplets are discharged onto the substrate W shall be referred to as the X axis direction, the direction perpendicular to the X axis direction on the horizontal plane as the Y axis direction, and the direction perpendicular to both the X axis direction and the Y axis direction as the Z axis direction.

The coating component 2 has a coating head 10 and a coating head moving device 12. The coating head 10 can be moved to any position of the substrate W on the coating stage 3 by the coating head moving device 12, and after moving to the discharge position, the coating head 10 discharges droplets from nozzles 11 at the discharge targets by inkjet method.

The coating head 10 has a substantially cuboid shape whose lengthwise direction is the Y axis direction, and a plurality of discharge units 13 are incorporated therein.

The discharge units 13 are provided with a plurality of nozzles 11, and the discharge units 13 are incorporated into the coating head 10, such that the nozzles 11 are arranged on the lower face of the coating head 10.

The coating head 10 communicates with a sub tank 15 via a pipe. The sub tank 15 is provided near the coating head 10, and has a role to temporarily store the coating liquid supplied from a main tank 16, which is provided separately from the sub tank 15, via a pipe, and to supply this coating liquid to the coating head 10 at high precision. The coating liquid supplied from the sub tank 15 to the coating head 10 is branched inside the coating head 10 and supplied to all the nozzles 11 of the discharge units 13.

The nozzles 11 each have a driving partition 14, and the controller 5 switches the discharge of each nozzle 11 on and off such that the driving partition 14 of a given nozzle 11 expands and contracts to discharge droplets. In this embodiment, piezo actuators are used as the drive partitions 14.

Also, in order to stabilize the discharge of the droplets from each nozzle 11, it is necessary for the coating liquid to stop while maintaining an interface (meniscus) of a predetermined shape within each nozzle 11 during coating standby, and therefore, a predetermined amount of negative pressure is imparted by a vacuum source 17 inside the sub tank 15. This negative pressure is regulated by a vacuum pressure regulating valve 18 provided between the sub tank 15 and the vacuum source 17.

The coating head moving device 12 has a scanning direction moving device 21, a shift direction moving device 22, and a rotating device 23, moves the coating head 10 in the X axis direction and the Y axis direction, and rotates the coating head 10 with the Z axis direction serving as the rotational axis.

The scanning direction moving device 21 is a linear movement mechanism formed by a linear stage or the like, and its drive is controlled by the controller 5 to move the coating head 10 in the X axis direction (scanning direction).

The scanning direction moving device 21 is driven to discharge droplets from the nozzles 11 while the coating head 10 scans above the substrate W, such that the coating liquid continuously coats the coating regions aligned in the X axis direction.

The shift direction moving device 22 is a linear movement mechanism formed by a linear stage or the like, and its drive is controlled by the controller 5 to move the coating head 10 in the Y axis direction (shift direction).

Consequently, if the discharge units 13 are spaced apart inside the coating head 10, coating is performed once while scanning the coating head 10 in the X axis direction, after which the coating head 10 is moved in the Y axis direction and coating is performed so as to compensate for the spacing, which makes it possible to coat the entire surface of the substrate W.

Also, even if the width of the substrate W in the Y axis direction is greater than the length of the coating head 10, it is possible to coat the entire surface of the substrate W by shifting the coating head 10 in the Y axis direction every time one coating operation is completed, and dividing up the coating into a plurality of passes.

The rotating device 23 is a rotation stage whose rotational axis is the Z axis direction, and its drive is controlled by the controller 5 to rotate the coating head 10.

The rotating device 23 adjusts the angle of the coating head 10 to adjust the spacing of the nozzles 11 in a direction (Y axis direction) perpendicular to the scanning direction of the coating head 10, and to obtain a spacing that is suited to the dimensions of the coating region and the size of the droplets.

The coating stage 3 has a mechanism for fixing the substrate W, and the coating of the substrate W is performed in a state in which the substrate W is placed on and fixed to the coating stage 3. In this embodiment, the coating stage 3 has a suction mechanism, and a vacuum pump or the like (not shown) is operated to generate a suction force on the face in contact with the substrate W and to hold the substrate W with suction.

The coating stage 3 can be moved in the X axis direction and the Y axis direction by a drive device (not shown) and can rotate with the Z axis direction serving as its rotational axis. After an alignment device (not shown) confirms an alignment mark on the substrate W that has been placed on the coating stage 3, the coating stage 3 is moved or rotated to correct any misalignment of the substrate W based on the confirmation result. Since the goal of the movement or rotation of the coating stage 3 is the fine adjustment of the placement state of the substrate W, the distance by which the coating stage 3 can move and the angle at which it can rotate can be very small.

Also, the substrate W on the coating stage 3 can be moved to directly under the lyophilicity adjuster 4, and after the lyophilicity of the substrate W has been adjusted by the lyophilicity adjuster 4 directly under the lyophilicity adjuster 4, the substrate W is moved to directly under the coating component 2, and a coating pattern is formed by the coating component 2.

In this embodiment, the lyophilicity adjuster 4 is an exposure device 24, and irradiates ultraviolet rays toward the substrate W.

Here, the substrate W in the present invention is, for example, a glass substrate, a silicon wafer, a resin film, or the like, and its surface is modified by irradiation with ultraviolet rays to change its lyophilicity. Since the degree of lyophilicity of the surface of the substrate W varies with how long the surface is irradiated with ultraviolet rays, in this embodiment the duration of ultraviolet irradiation from the lyophilicity adjuster 4 to each position on the substrate W is controlled by the controller 5, and the degree of lyophilicity at each position on the substrate W is adjusted.

Also, even at a given irradiation time, the degree of lyophilicity can be adjusted by varying the wavelength or intensity of the ultraviolet rays. Therefore, the lyophilicity adjuster 4 can be designed such that the wavelength or intensity of the ultraviolet rays in ultraviolet irradiation of each position of the substrate W is controlled by the controller 5 such that the degree of lyophilicity at each position of the substrate W will be adjusted. In addition, the configuration can be such that a plurality of lyophilicity adjusters 4 that emit ultraviolet rays in different wavelengths or intensities are provided, and these lyophilicity adjusters 4 are used selectively under the control of the controller 5 to adjust the lyophilicity at each position of the substrate W.

Also, the lyophilicity adjuster 4 can be provided to the scanning direction moving device 25 and the shift direction moving device 26 such that when these moving devices are driven, the lyophilicity adjuster 4 moves in the X axis direction and the Y axis direction.

The scanning direction moving device 25 is a linear movement mechanism formed by a linear stage or the like, and its drive is controlled by the controller 5 to move the lyophilicity adjuster 4 and the shift direction moving device 26 in the X axis direction.

The shift direction moving device 26 is a linear motion mechanism formed by a linear stage or the like, and its drive is controlled by the controller 5 to move the lyophilicity adjuster 4 in the Y axis direction.

Controlling the drive of the scanning direction moving device 25 and the shift direction moving device 26 with the controller 5 causes the lyophilicity adjuster 4 to move relatively in the X axis direction and the Y axis direction with respect to the substrate W placed on the coating stage 3, thereby changing the lyophilicity at the desired positions on the substrate W.

The controller 5 has a computer, a sequencer, and so forth, and controls the feed of liquid to the coating head 10, the discharge of droplets from the nozzles 11, the adjustment of the discharge amount, the operation of the lyophilicity adjuster 4, and the like.

The controller 5 has a storage device that stores various kinds of information and is composed of a hard disk, a RAM, a ROM, or another such memory. Coordinate data about the droplet discharge position for forming a coating film within the pattern region (discussed below) in the process of applying the droplets is stored in this storage device. Other data necessary for coating and adjustment of the lyophilicity of the pattern region is also stored in this storage device.

Next, the coating pattern formation method of the present invention, performed using the coating pattern formation device 1, will be described.

FIG. 2 is a diagram of the substrate according to this embodiment.

As described above, with the present invention, before the coating component 2 discharges the droplets onto the substrate W, the lyophilicity adjuster 4 adjusts the lyophilicity of the pattern region 52, which is the region on the substrate W where the coating pattern 51 is formed, and the way in which the coating liquid spreads out after the formation of the coating pattern is controlled in advance.

Specifically, the entire surface of the substrate W is originally formed with the same lyophilicity as that of the outer peripheral portion 53, which is the portion outside of the pattern region 52, but the area corresponding to the pattern region 52 is irradiated with ultraviolet rays such that the lyophilicity of the irradiated portion is raised over that of the outer peripheral portion 53.

The result of thus raising the lyophilicity of the pattern region 52 over that of the outer peripheral portion 53 in the substrate W is that even when the coating liquid that has been applied to the pattern region 52 of the substrate W from the coating head 10 of the coating pattern formation device 1 spreads out on the substrate W, the coating liquid stays inside the pattern region 52, which prevents the coating liquid from spreading out beyond the boundary between the pattern region 52 and the outer peripheral portion 53, so the coating pattern 51 in the shape of the pattern region 52 can be easily obtained.

In this description, the step of adjusting the lyophilicity of the pattern region 52 before applying the coating liquid is called the lyophilicity adjustment step, and the step of applying the coating liquid toward the pattern region 52 after the lyophilicity adjustment step, and forming the coating pattern 51 having the shape of the pattern region 52 is called the pattern formation step.

Here, the pattern region 52 of the substrate W according to the coating pattern formation method of the present invention is divided into a plurality of small pattern regions in at least one direction. In the example in FIG. 2, the pattern region 52 is divided into one small pattern region 54, four small pattern regions 55, and four small pattern regions 56, indicated by hatching. In the portions joined by the one-dot chain line in FIG. 2, the pattern region 52 is divided up such that the small pattern regions are aligned in the order of the small pattern region 55, the small pattern region 54, and the small pattern region 55 in the X axis direction.

The small pattern region 54, the small pattern regions 55, and the small pattern regions 56 each have different lyophilicity, and denser hatching indicates a higher lyophilicity. That is, among these three kinds of small pattern region, the small pattern region 54 has the lowest lyophilicity, and the small pattern regions 56 have the highest lyophilicity. These three kinds of small pattern regions are disposed such that the small pattern region 54 having the lowest lyophilicity is disposed at a position other than the ends of the pattern region 52, and the lyophilicity of the small pattern regions increases from the small pattern region 54 toward the ends of the pattern region 52.

In this description, “divided” indicates that regions are arranged side by side as small pattern regions of different lyophilicity, but there is no need at all for the small pattern regions to be physically divided.

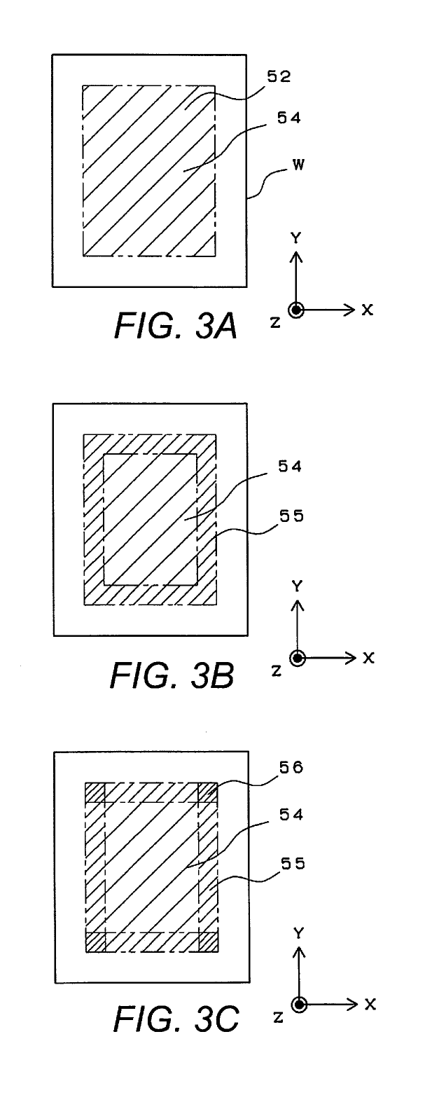

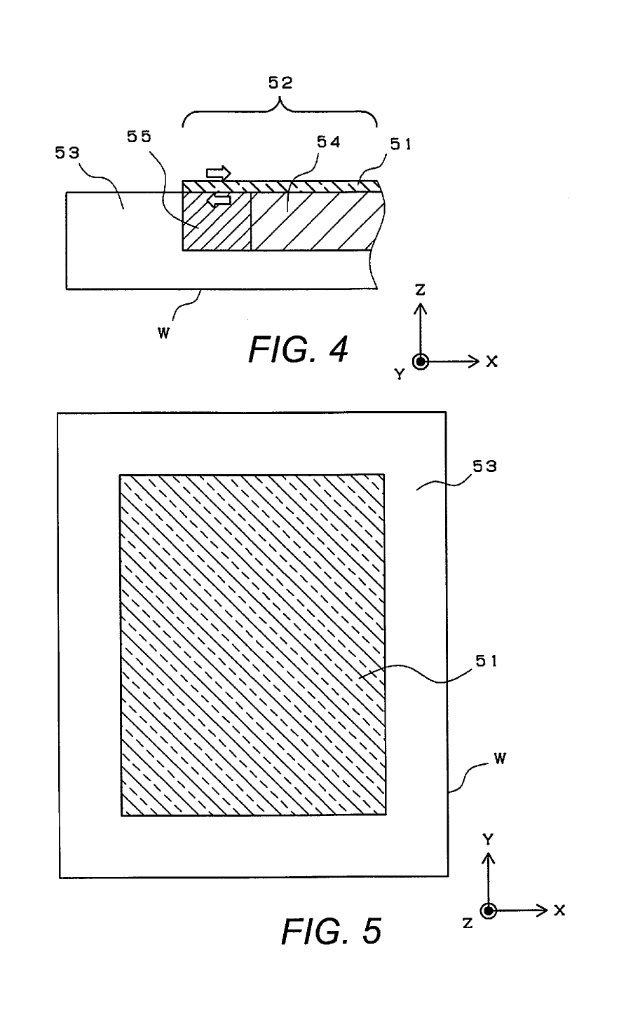

FIGS. 3A, 3B and 3C show the procedure of dividing the small pattern regions according to this embodiment.

First, the whole pattern region 52 is irradiated by the lyophilicity adjuster 4 to form the small pattern region 54.

Next, the portions corresponding to the ends of the pattern region 52 are further irradiated. This further irradiation increases the irradiation time and forms the small pattern regions 55 having higher lyophilicity than the small pattern region 54.

Finally, the portions corresponding to the corners of the pattern region 52 are further irradiated. This further irradiation increases the irradiation time and forms the small pattern regions 56 having higher lyophilicity than the small pattern regions 55. These operations complete the formation of the pattern region 52 in which the lyophilicity increases from the small pattern region 54 toward the ends of the pattern region 52.

Next, FIG. 4 shows how the coating pattern 51 behaves when the coating liquid is applied to the pattern region 52 divided up into a plurality of small pattern regions.

In this embodiment, when forming the coating pattern 51 on the substrate W, the coating liquid is applied to the entire pattern region 52. At this time, the surface tension of the coating pattern 51 itself exerts a force that pulls in the coating pattern 51 toward the center as indicated by the top arrow in FIG. 4, especially in the corners of the coating pattern 51.

However, as described above, in the present invention the pattern region 52 is divided up into a plurality of small pattern regions such that the lyophilicity increases toward the ends of the pattern region 52. Consequently, the coating liquid that forms the coating pattern 51 tries to flow from an area of lower lyophilicity to one of higher lyophilicity, so there is a force that pushes back on the coating pattern 51 in the opposite direction from that of the surface tension that pulls it toward the center, as shown by the lower arrow in FIG. 4. Therefore, the coating liquid spreads out so as to suppress the deformation of the coating pattern 51 due to surface tension, and a coating-patterned substrate can be obtained in which the coating pattern 51 is formed in the shape of the pattern region 52, as shown in FIG. 5.

In the embodiment in FIG. 2, small pattern regions 56 having the highest lyophilicity are provided at least in the corners of the pattern region 52. As a result, the coating liquid spreads out all the way to the corners where deformation of the coating pattern 51 due to surface tension is most likely to occur, deformation of the coating pattern 51 can be suppressed, and a coating-patterned substrate can be obtained in which a coating pattern 51 with a more accurate shape is formed.

Both the small pattern regions 55 and the small pattern regions 56 forming the ends of the pattern region 52 have higher lyophilicity than the outer peripheral portion 53. This prevents the coating liquid from spreading out so much that it overflows out of the pattern region 52.

It is possible to form a coating pattern according to a preset shape by means of the coating pattern formation method, the coating pattern formation device, and the coating-patterned substrate described above.

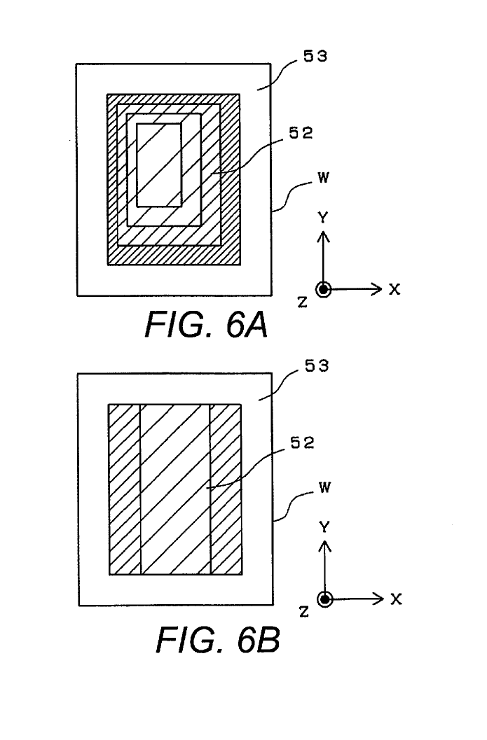

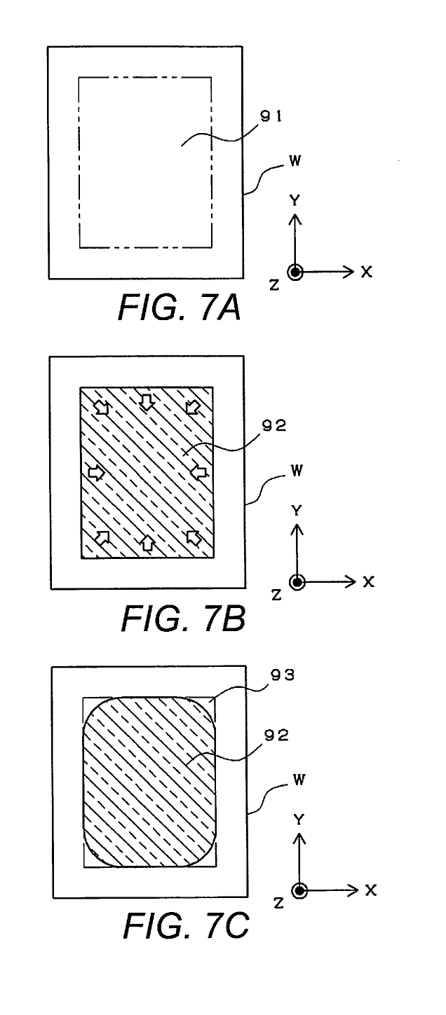

Here, the coating method of the present invention is not limited to what is described above, and can be of some other form within the scope of the present invention. For instance, in the embodiment in FIG. 2, the number of small pattern regions in one direction (the division direction) is three at the portion indicated by the one-dot chain line in FIG. 2, but there can be more than three such regions, as shown in FIG. 6A. In addition, as shown in FIG. 6A, the small pattern region having the lowest lyophilicity is not necessarily the center of the pattern region 52.

In the embodiment in FIG. 2, small pattern regions are divided in a plurality of directions such as the X axis direction and the Y axis direction, but, the small pattern regions can instead be divided in only one direction as shown in FIG. 6B.

In the above embodiment, the coating pattern is formed in the rectangular pattern region 52, but this is not the only option, and the present invention can also be applied to the formation of a coating pattern having a complicated shape such as a wiring circuit, and the present invention can also be applied to the formation of a curved coating pattern.

In the above description, the lyophilicity adjuster 4 is an exposure apparatus, but some other form can be used instead. For example, the lyophilicity of the surface of the substrate W can be adjusted by irradiation with a laser beam, or the lyophilicity of the surface of the substrate W can be adjusted by using heat.

1. A coating pattern formation method in which a coating liquid comprising:
adjusting lyophilicity of a pattern region provided on a substrate; and
forming a coating pattern having a shape of the pattern region by applying a coating liquid to the pattern region after the adjusting of the lyophilicity of the pattern region,
the lyophilicity of the pattern region being adjusted such that the pattern region is divided into a plurality of small pattern regions in at least one division direction, such that adjacent small pattern regions have different lyophilicity, such that a small pattern region spaced away from an end of the pattern region has the lowest lyophilicity among the small pattern regions in the at least one division direction, and such that the lyophilicity of the small pattern regions increases from the small pattern region having the lowest lyophilicity toward the end of the pattern region.

2. The coating pattern formation method according to claim 1, wherein
the lyophilicity of the pattern region is adjusted such that one of the small pattern regions that is provided in a corner of the pattern region has the highest lyophilicity among the small pattern regions forming the pattern region.

3. The coating pattern formation method according to claim 1, wherein
the lyophilicity of the pattern region is adjusted such that one of the small pattern regions including the end of the pattern region has higher lyophilicity than lyophilicity of a portion of the substrate outside the pattern region and adjacent to the pattern region.

4. A coating pattern formation device comprising:
a lyophilicity adjuster configured to adjust lyophilicity of a pattern region provided on a substrate; and
a coating component configured to form a coating pattern having a shape of the pattern region by applying a coating liquid to the pattern region,
the lyophilicity adjuster being further configured to adjust the lyophilicity of the pattern region such that the pattern region is divided into a plurality of small pattern regions in at least one division direction, such that adjacent small pattern regions have different lyophilicity, a small pattern region spaced away from an end of the pattern region has the lowest lyophilicity among the small pattern regions in the at least one division direction, and such that the lyophilicity of the small pattern regions increases from the small pattern region having the lowest lyophilicity toward the end of the pattern region.

5. A coating-patterned substrate comprising:
a substrate having a surface with a pattern region; and
a coating pattern disposed on the pattern region of the surface of the substrate,
the pattern region being divided into a plurality of small pattern regions in at least one division direction, with adjacent small pattern regions having different lyophilicity,
a small pattern region spaced away from an end of the pattern region having the lowest lyophilicity among the small pattern regions in the at least one division direction, and
the lyophilicity of the small pattern regions increasing from the small pattern region having the lowest lyophilicity toward the end of the pattern region.

6. The coating pattern formation method according to claim 2, wherein
the lyophilicity of the pattern region is adjusted such that one of the small pattern regions including the end of the pattern region has higher lyophilicity than lyophilicity of a portion of the substrate outside the pattern region and adjacent to the pattern region.

7. The coating pattern formation method according to claim 1, wherein
the adjusting of the lyophilicity of the pattern region includes irradiating the pattern region with ultraviolet ray.

8. The coating pattern formation method according to claim 1, wherein
the adjusting of the lyophilicity of the pattern region includes irradiating the pattern region with laser beam.

9. The coating pattern formation method according to claim 1, wherein
the adjusting of the lyophilicity of the pattern region includes adjusting the lyophilicity of the pattern region with heat.

10. The coating pattern formation method according to claim 1, wherein
the adjusting of the lyophilicity of the pattern region includes adjusting the lyophilicity of an entire area of the pattern region, and adjusting the lyophilicity of an end area of the pattern region including the end of the pattern region after the adjusting of the lyophilicity of the entire area of the pattern region.

11. The coating pattern formation method according to claim 10, wherein
the adjusting of the lyophilicity of the pattern region further includes adjusting the lyophilicity of a corner area of the pattern region including a corner of the pattern region after the adjusting of the lyophilicity of the end area of the pattern region.

12. The coating pattern formation method according to claim 1, wherein
the adjusting of the lyophilicity of the pattern region includes irradiating an entire area of the pattern region with ultraviolet ray, and irradiating an end area of the pattern region including the end of the pattern region with the ultraviolet ray after the irradiating of the entire area of the pattern region with the ultraviolet ray.

13. The coating pattern formation method according to claim 12, wherein
the adjusting of the lyophilicity of the pattern region further includes irradiating a corner area of the pattern region including a corner of the pattern region with the ultraviolet ray after the irradiating of the end area of the pattern region with the ultraviolet ray.
